(19) United States
(12) Patent Application Publication
(10) Pub. No.: US 2009/0140023 A1
(43) Pub. Date: Jun. 4, 2009

(54) Eat on the go travel tray for auto window or lap

(76) Inventor: Angela Gale Noble, Ravenswood, WV (US)

Correspondence Address: Angela Gale Noble, Rt. 1, Box 37A, Ravenswood, WV, 26164, US

(21) Appl. No.: 12/313,544

(22) Filed: Nov. 21, 2008

Related U.S. Application Data
(60) Provisional application No. 61/004,020, filed on Nov. 21, 2007.

(51) Int. Cl. B60N 3/10

(52) U.S. Cl. 224/482

(57) ABSTRACT

A travel tray for holding food and beverage items to be utilized by either the driver or passenger of an automobile; or by a person outside of an automobile. The travel tray has a unique automobile window insert and/or accompanying window tool by which the travel tray may be attached to an automobile window. The travel tray may also be utilized in its lap position when not attached to an automobile window or door. The travel tray also collapses when not in use into a convenient and easily carried and stored configuration.

### CROSS-REFERENCE TO RELATED APPLICATIONS

This application claims priority of U.S. Provisional Patent Application No. 61/004,020 filed Nov. 21, 2007, entitled “Eat on the Go Travel Tray for Auto Window or Lap.”

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### FIELD OF THE INVENTION

This invention relates, generally, to a travel tray for holding food and beverage items to be utilized by either the driver or passenger of an automobile; or by a person outside of an automobile. More specifically, it relates to such a travel tray having a unique automobile window insert and/or accompanying window tool by which the travel tray may be attached to an automobile window or door. In addition, it relates to a travel tray which may also be utilized in its' lap position when not attached to an automobile window or door. The travel tray of the present invention, when not in use, collapses into a convenient and easily carried and stored configuration.

1. Background of the Invention

Due to the fast paced life style of the world we live in, it has become common practice for millions of people each day to grab a bite to eat on the go. Traveling to and from work, running errands, picking up the kids and shuffling them back and forth to school and extracurricular activities, and taking long trips, are all times when a sit down meal at home may not be possible and we find ourselves eating in our automobiles or bringing our food along with us to eat while watching the kids play soccer or participate in some such other activity. During these times, many people patronize a fast-food restaurant's drive-thru or bring along food and beverages to consume in their automobiles or at the ball field. Unfortunately, many people find that eating in an automobile or, for instance, at the ball field, is not convenient and poses certain difficulties, such as where to sit the sandwich, where to put the French fries, where to put the ketchup and sauces. Placing these items in your lap can be messy at any time and even hazardous while driving.

2. Discussion of the Prior Art

Prior to now, portable travel trays have not provided an adequately convenient and comfortable method for holding food and beverage items. Previous attempts have been made to provide a travel tray for facilitating the consumption of food and beverages. A search of the U.S. Patent and Trademark Office files revealed the following prior art patents:

U.S. Pat. No. 5,269,229, issued to Akapatangkul on Dec. 14, 1993, discloses a Retractible Tray Assembly for Use on a Vehicle Seat Back, e.g. on the rear surface of the front seat of an automobile. Unlike the present invention, the Retractible Tray Assembly cannot be used in the front seat of an automobile, and cannot be used outside of the automobile.

U.S. Pat. No. 5,069,375, issued to Flick on Dec. 3, 1991, discloses a Vehicle Fast Food Tray that is intended to be secured while resting on the lap of an occupant of a motor vehicle and being strapped to the seatbelt. The Vehicle Fast Food Tray must rest directly on the lap of the user and thus fails to provide the comfort and convenience to the driver of an automobile that is afforded by the present invention which can be attached to the automobile window and not interfere with the driver's ability to operate the vehicle.

U.S. Pat. No. 5,427,292, issued to Rousch on Jun. 27, 1995, discloses a Traveler's Tray that is intended to be placed over the legs of a user sitting in either the front or back seat of a vehicle. The Traveler's Tray must rest directly over the legs of the user and thus fails to provide the comfort and convenience to the driver of an automobile afforded by the present invention which can be attached to the automobile window and not interfere with the driver's ability to operate the vehicle.

U.S. Pat. No. 5,671,479, issued to Dedrick on Sep. 30, 1997, discloses a Reversibly Collapsible Lap Tray to cover the wearer's lap and a foldable bib attached to the Lap Tray. The Reversibly Collapsible Lap Tray does not address the use of a lap tray requiring high sides to keep food and other items from sliding off the tray and does not include a cupholder or pockets for food and condiments.

U.S. Pat. No. 5,749,305, issued to Jacovelli on May 12, 1998, discloses a Tray for Use in Automobiles that can be attached to the steering wheel of a car or truck for dining, writing or other purposes. The Tray for Use in Automobiles does not address the use of a travel tray by the driver while operating the automobile and cannot be used by the other automobile passengers or by persons outside of the automobile.

U.S. Pat. No. 5,862,933, issued to Neville on Jan. 26, 1999, discloses a Portable Lap Tray for securing to a user's thighs for use inside of a vehicle. The Portable Lap Tray must rest directly on the lap of the user and thus fails to provide the comfort and convenience to the driver of an automobile afforded by the present invention which can be attached to the automobile window and not interfere with the driver's ability to operate the vehicle.

U.S. Pat. No. 6,116,166, issued to Rotstein on Sep. 12, 2000, discloses a Child's Collapsible Travel Tray for attaching the tray to the child's waist while at the same time securing a portion of the tray against the child's body. This Child's Collapsible Travel Tray does not address the needs of the driver of the automobile or the other adult passengers in the automobile and also fails to provide the comfort and convenience afforded by the present invention which can be attached to the automobile window and not interfere with the driver's ability to operate the vehicle.

U.S. Pat. No. 6,305,532 B1, issued to Overkamp on Oct. 23, 2001, discloses a legless Travel Tray Having Adjustable Drink Holder for holding food items and a beverage container on a user's lap. The Travel Tray must rest directly on the lap of the user and thus fails to provide the comfort and convenience to the driver of an automobile afforded by the present invention which can be attached to the automobile window and not interfere with the driver's ability to operate the vehicle.

U.S. Pat. No. 6,807,902 B1, issued to Ginter on Oct. 26, 2004, discloses an Adjustable Folding Travel Tray for the cab of a tractor trailer truck. The Adjustable Folding Travel Tray must be fastened into position in a vehicle on the inward facing side of a bucket seat. Most vehicles do not have room to allow for installation of the Adjustable Folding Travel Tray and, thus, it fails to provide the comfort and convenience afforded by the present invention which can be attached to the automobile window and not interfere with the driver's ability to operate the vehicle; and further, it does not address the use of a travel tray by persons outside of an automobile.

U.S. Pat. No. 6,932,214 B1, issued to Zimet on Aug. 23, 2005, discloses a Disposable Car Fast Food Box that also serves as a tray for holding the food and drink while eating in a vehicle. The Disposable Car Fast Food Box rests directly on the lap of the user and cooperates with the vehicle seat belt to hold the tray in place and, thus, fails to provide the comfort and convenience to the driver of an automobile afforded by the present invention which can be attached to the automobile window and not interfere with the driver's ability to operate the vehicle.

U.S. Patent Number 2007/0277711 A1, issued to Grant on Dec. 6, 2007, discloses an Impact Collapsible Non-Rigid Lap Tray with Four Surrounding High Sides, which rests of the lap of the user. Therefore, said tray fails to provided the comfort and convenience to the driver of an automobile afforded by the present invention which can be attached to the automobile window and not interfere with the driver's ability to operate the vehicle. Further, said tray does not include a cupholder or pockets for food and condiments.

While there are numerous inventions for automobile travel trays in the prior art, none are equivalent to the present invention.

### BRIEF SUMMARY OF THE INVENTION

In view of the foregoing disadvantages inherent in the travel trays set forth in the prior art, the present invention provides an improved travel tray for holding food and beverage items to be utilized by either the driver or passenger of an automobile; or by a person outside of an automobile. Further, the present invention having a unique automobile window insert and/or accompanying window tool by which it may be attached to an automobile window or door. In addition, said invention may also be utilized in its' lap position when not attached to an automobile window or door.

The invention of this disclosure is made from fabric, vinyl, ribbon and hard plastic using conventional sewing methods and consists, generally, of: the “tray bottom” upon which larger food items are placed; a “tray lip” which, together with the below referenced tray back, provides a continuous barrier that prevents food items from sliding off the tray bottom; said tray lip containing on both its left and right sides “ketchup pockets” for holding ketchup packets in an upright position; “back supports” on both the left and right sides which abut the below referenced tray back, thus holding the tray in its upright locked open position; a “window tool” to allow for ease in pulling back a small portion of the automobile window's rubber surround allowing the below described window insert to slide into place thus allowing the tray to hang down from the window; a “tray back” containing a “small pocket” for holding sauce products, a “cupholder” stored in a folded position, and a “large pocket” for holding french fries or various taller or open topped containers of food items; the cupholder accommodating beverage containers from small to extra large sizes; a “drawstring” used to adjust the tray bottom to allow for its use in the most level manner possible; an “adjustable section” as a means to adjust the tray up or down when being used in its hanging position, or to be folded backward when the tray is used in its lap position; an “automobile window insert section” and “automobile window insert” allowing the tray to hang down from the automobile window as described herein.

The travel tray of the present invention, when not in use, collapses into a convenient and easily carried and stored configuration in its “storage position.”

Accordingly, it is an an object of the present invention to provide an improved travel tray for holding food and beverage items to be utilized by either the driver or passenger of an automobile; or by a person outside of an automobile.

It is a further object of the present invention to provide an improved travel tray having a unique automobile window insert and/or accompanying window tool by which it may be attached to an automobile window or door.

It is a further object of the present invention to provide an improved travel tray having a tray bottom upon which larger food items are placed, and a tray lip and tray back that prevents food items from sliding off the tray bottom;

It is a further object of the present invention to provide an improved travel tray having ketchup pockets for holding ketchup packets in an upright position;

It is a further object of the present invention to provide an improved travel tray having back supports which, when in use, allow the travel tray to remain in an upright locked open position;

It is a further object of the present invention to provide an improved travel tray having a window tool for ease in pulling back a small portion of the automobile window's rubber surround allowing a window insert to slide into place thus allowing the tray to hang down from the window;

It is a further object of the present invention to provide an improved travel tray having separate pockets for holding sauce products, french fries or other various taller or open topped containers of food items;

It is a further object of the present invention to provide an improved travel tray having a cupholder accommodating beverage containers from small to extra large sizes;

It is a further object of the present invention to provide an improved travel tray having a drawstring to adjust for use in the most level manner possible, and an adjustable section as a means to adjust the tray up or down when being utilized in its hanging position;

It is a further object of the present invention to provide an improved travel tray which collapses into a convenient and easily carried and stored configuration in its storage position.

These together with other objects of the invention, along with the various features of novelty which characterize the invention, will become more apparent hereinafter. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed descriptions thereof. Such descriptions make reference to the annexed drawings wherein:

FIG. 1 is a side view of the invention depicting the tray bottom with the tray lip, the ketchup pockets, the back supports, the window tool in its storage compartment, the tray back holding the cupholder in its closed and stored position, the small and large pockets, the drawstring, together with the adjustable section and window insert section extended upward in an open position.

FIG. 2 is an upper side view of the invention in its lap position with the adjustable section and window insert section folded back and under, and depicting the tray bottom with the tray lip, the cupholder in its open and in use position on the right side, the ketchup pockets, the back supports, the tray back with the attached small and large pockets, and the drawstring.

FIG. 3 is a depiction of the window tool in use pulling back the window rubber surround in preparation for insertion of the window insert.

FIG. 4 is a depiction of the invention showing the window tool in use allowing for the insertion of the window insert portion of the Eat on the Go Travel Tray between the window glass and the window rubber surround on the automobile driver's side door.

FIG. 5 is a depiction of the invention showing the window insert in place between the window glass and the window rubber surround on the automobile driver's side door.

FIG. 6 is a depiction of the invention in place on the automobile driver's side door.

FIG. 7 is a depiction of the invention in use by an automobile passenger on the passenger's front side door, with the window insert being between the window glass and the window rubber surround.

FIG. 8 is a depiction of the invention in its lap position in use by a person either inside or outside of an automobile.

FIG. 9 is an overhead view of the invention in its fully closed storage position.

FIG. 10 is a side view of the invention in its fully closed storage position.

### DETAILED DESCRIPTION OF THE INVENTION

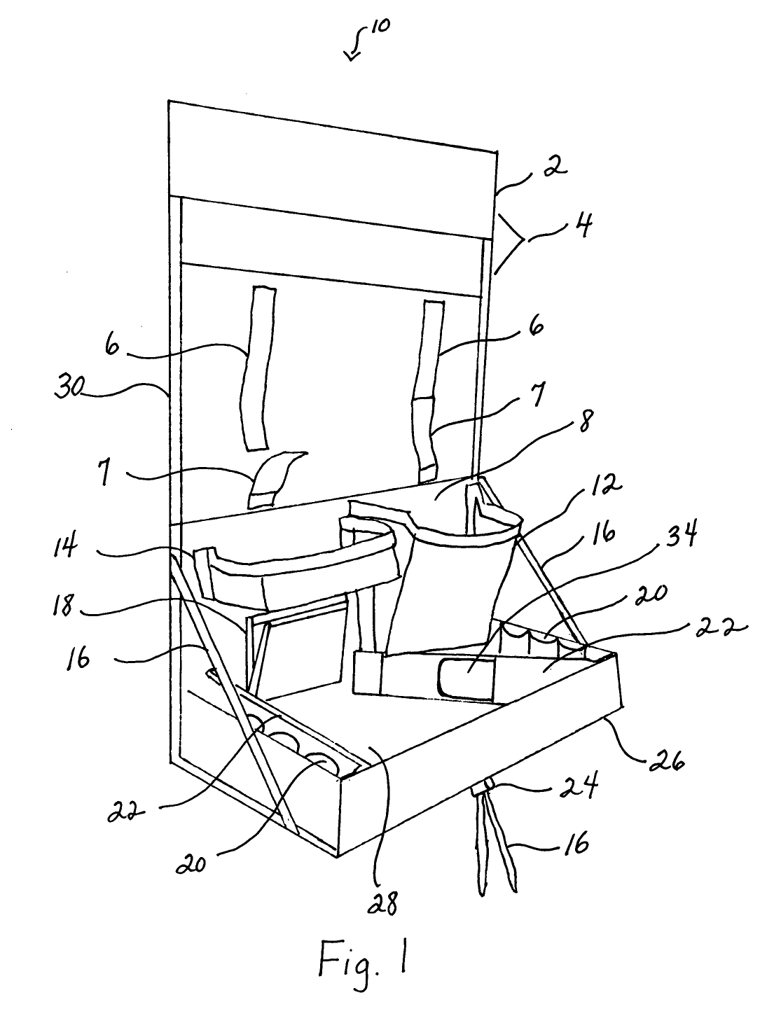

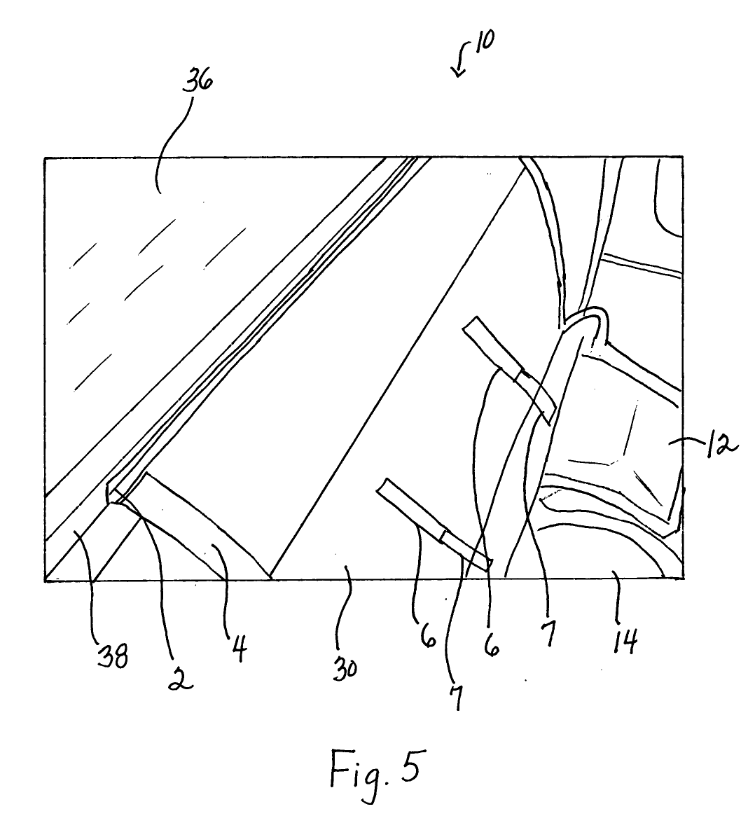

Referring now to FIGS. 1, 2, 4, 5, 6, 7, 8, 9 and 10, it will there be seen that an illustrative embodiment of the present invention, or a portion thereof, is denoted as a whole by the reference number 10. This invention may be, generally, described as follows:

1. FIGS. 1, 2 and 4 through 10 illustrate the travel tray 10 of the invention, more particularly described hereinbelow, for holding food and beverage items while a person is either inside or outside of an automobile; and

2. FIGS. 1 through 10 illustrate the unique automobile window insert 2 and/or accompanying window tool 34, more particularly described hereinbelow, by which the travel tray 10 herein described may be attached to an automobile window 36 or door. (The automobile window insert 2 may also be attached to all manner of cupholders, cellphone holders, sunglasses holders, accessory trays/holders, and any and all types of holders, trays, containers, vessels, receptacles, or any and all items whatsoever, to allow them to be attached to an automobile window or door.)

The Eat on the Go Travel Tray for Auto Window or Lap 10 is useable by the following persons:

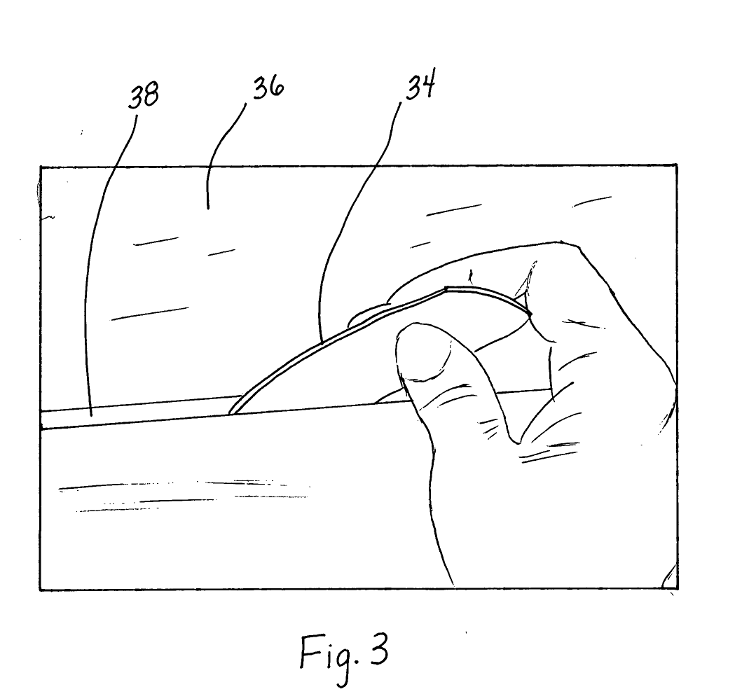

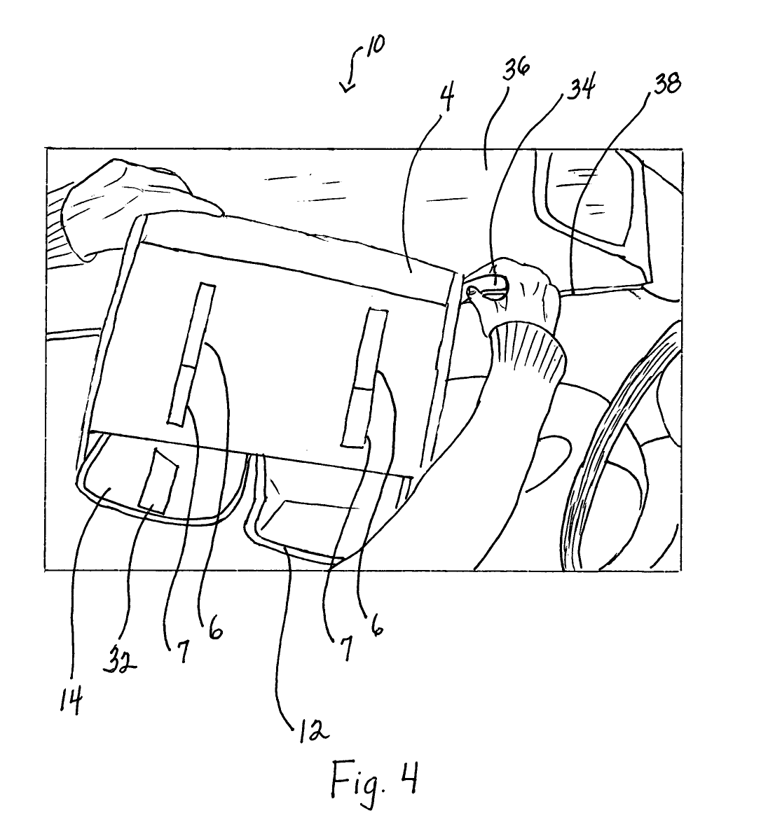

(a) The driver of an automobile as illustrated in FIGS. 4 through 6 by means of sliding a portion of the tray 10 (the “automobile window insert” 2) between the automobile window 36 and its rubber surround 38 by means of a provided window tool 34, such process of positioning the invention being illustrated in FIGS. 3 and 4 thus allowing the tray 10 to hang down from the window 36 and rest on the door of the automobile (the “hanging position” as illustrated in FIGS. 4 through 7), thereby being readily accessible to the driver without the necessity of diverting attention from driving tasks and allowing food or drink items to be quickly returned to the tray 10; and

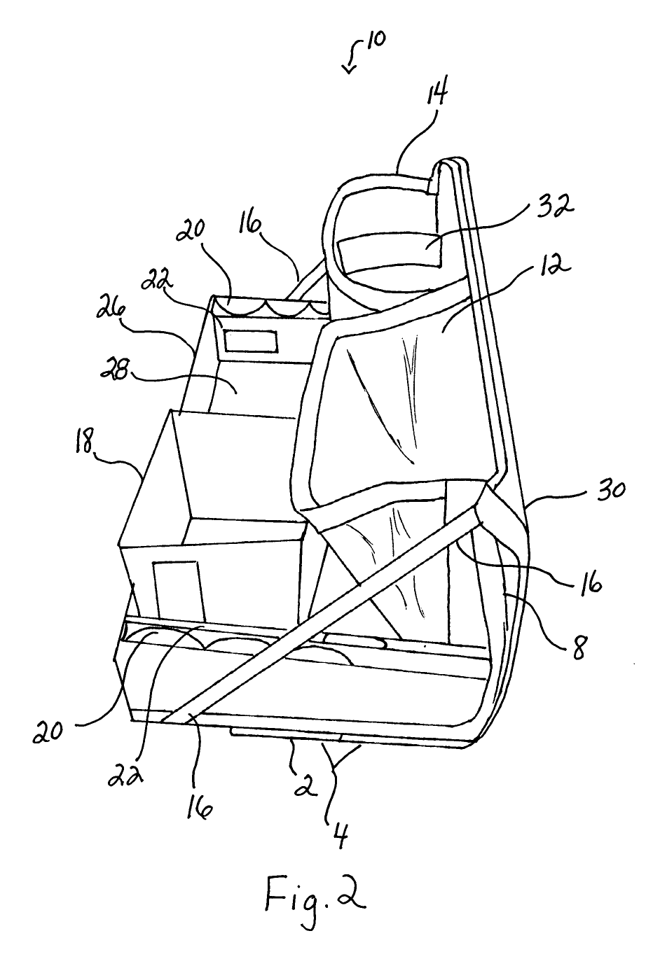

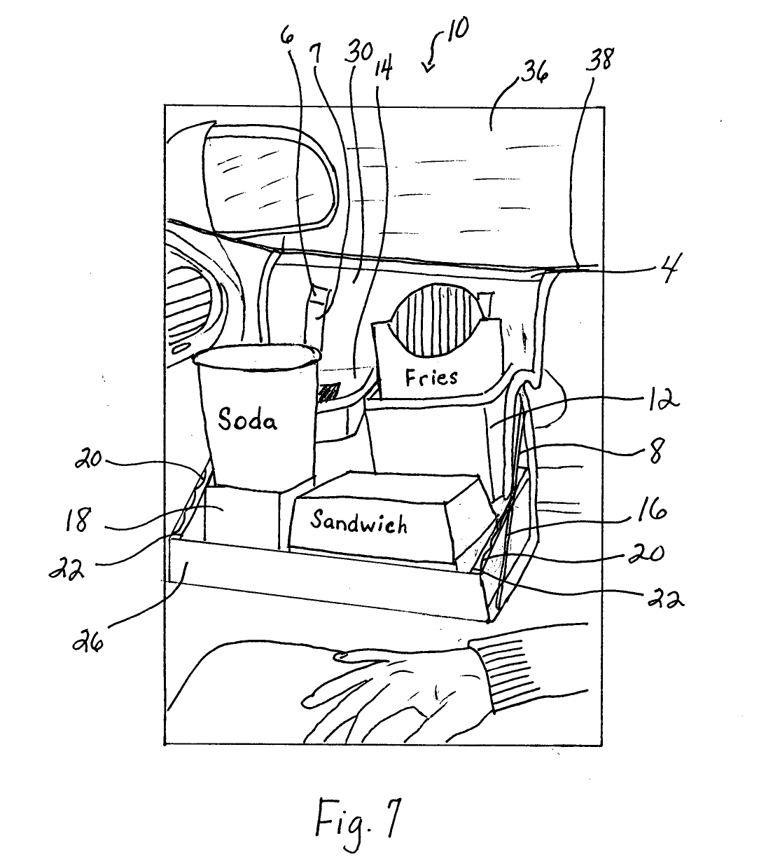

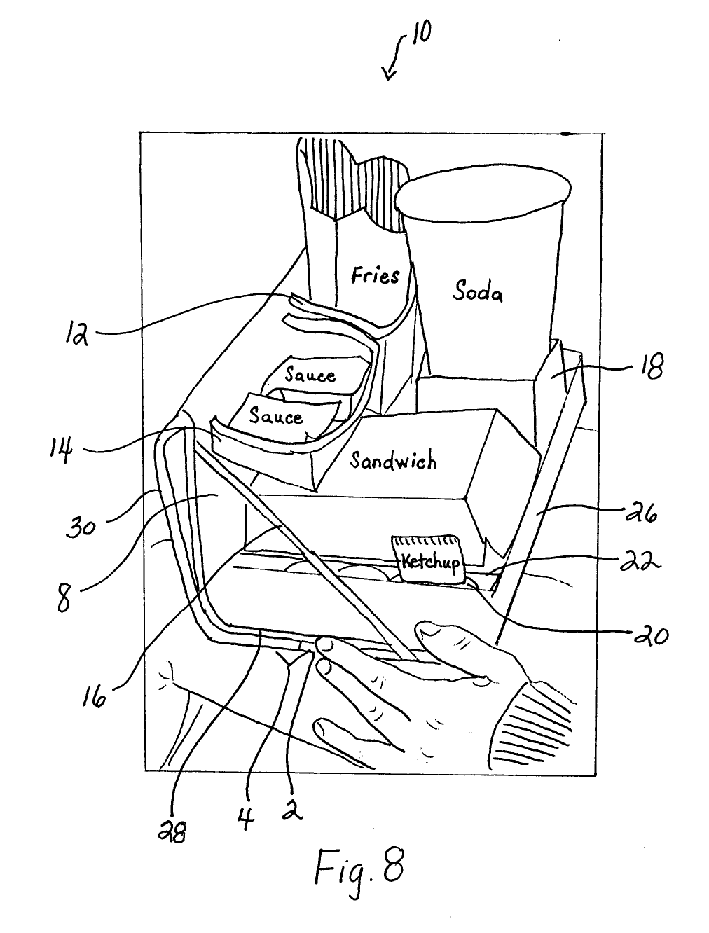

(b) The passengers in an automobile as illustrated in FIGS. 7 and 8 either by means of the above hanging position illustrated in FIGS. 4 through 7, thus allowing the tray to hang down from the window 36 and rest on the door of the automobile or the body of the automobile if there is no door, whichever the case may be, or by resting the tray 10 on their laps in its upright locked open position with the automobile window insert 2 tucked under (the “lap position” as illustrated in FIGS. 2 and 8); and

(c) Persons outside of an automobile by means of the above lap position as illustrated in FIGS. 2 and 8.

The Eat on the Go Travel Tray for Auto Window or Lap 10 may be made from fabric, vinyl, ribbon and hard plastic using conventional sewing methods and consists, generally, of the following:

(a) As illustrated in FIGS. 1, 2, and 6 through 10, a bottom flat surface being approximately 11½″ wide×6″ deep (the “tray bottom” 28) made from fabric surrounding a corresponding hard plastic upon which larger food items, such as hamburgers or various sandwiches are placed;

(b) As illustrated in FIGS. 1, 2 and 6 through 8, said tray bottom 28 being surrounded in the front and on both the left and right sides by a lip rising 1½″ from said tray bottom 28 at a 90 degree angle (the “tray lip” 26) and being made from fabric surrounding, in the front, a corresponding hard plastic, thus providing, together with the below referenced tray back 8, a continuous barrier that prevents food items from sliding off the tray bottom 28;

(c) As illustrated in FIGS. 1, 2 and 6 through 8, said tray lip 26 rising from said tray bottom 28 containing on both its left and right sides three (3) vinyl open ended pockets each for holding ketchup packets in an upright position (the “ketchup pockets” 20)

(d) As illustrated in FIGS. 1, 2 and 6 through 8, said tray lip 26 rising from said tray bottom 28 having attached in both its left and right front corners back supports 22 being of the same shape as the front portion of the tray lip 26 and being approximately 1½″ high×6″ long (the “back supports” 22) and being made from fabric surrounding a corresponding hard plastic, which, in their closed positions lie along the front portion of the tray lip 26 and hook to each other by means of hook and loop fasteners, and in their open positions swing to the back of the tray bottom 28, one (1) on the left and one (1) on the right, and abut the below referenced tray back 8, thus holding the tray in its upright locked open position as illustrated in FIGS. 1, 2 and 6 through 8;

(e) As illustrated in FIG. 1, said back support 22 being attached on the right front corner of the tray lip 26 also containing a slot for the storage of a tool 34 being made from hard plastic and measuring approximately 4½″ long×1⅛″ high (the “window tool” 34) and having rounded and thinned out corners to allow for ease in pulling back a small portion of the automobile window's rubber surround 38 allowing the below described automobile window insert 2 to slide into place (said positioning being illustrated in FIGS. 3 and 4), thus allowing the tray 10 to hang down from the window 36 and rest on the door of the automobile, or the body of the automobile if there is no door, whichever the case may be, in the hanging position as illustrated in FIGS. 4 through 7.

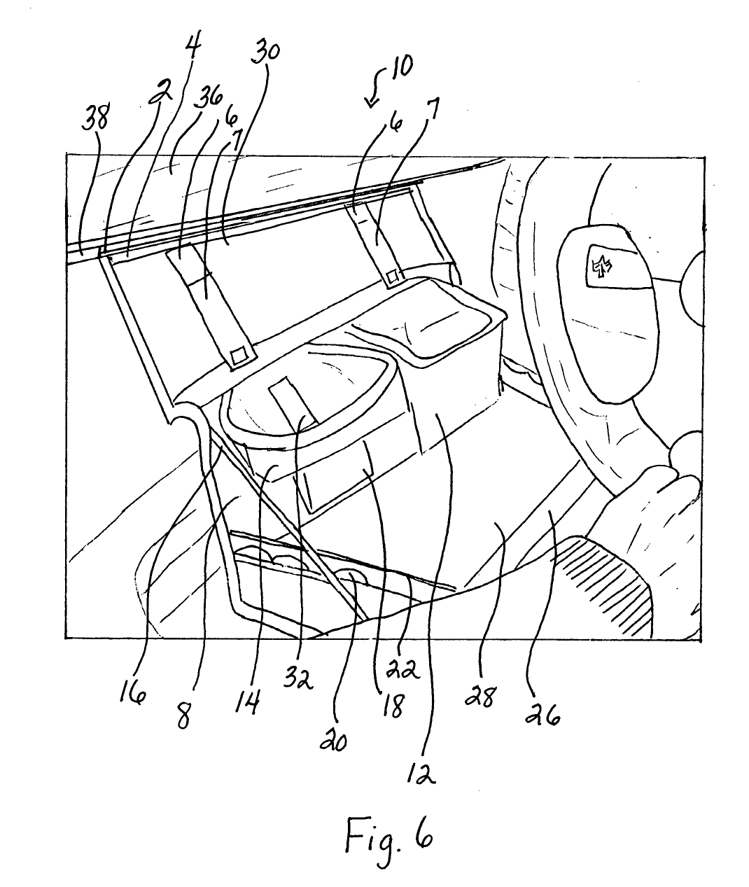

(f) As illustrated in FIGS. 1, 2 and 4 through 8, a back section 8 rising at a 90 degree angle from the rear of the tray bottom 28 being approximately 11½″ wide×6″ high (the “tray back” 8) and containing, on the upper left, a smaller pocket 14 being approximately 4½″ wide×1″ high×2″ deep for holding up to approximately three (3) standard sized sauce products (the “small pocket” 14); on the lower left, a cupholder 18 being approximately 3″ square (the “cupholder” 18) stored in a folded position as illustrated in FIGS. 1 and 6 and being attached with hook and loop fasteners; and, on the right, a larger pocket 12 being approximately, at its largest point, 4¾″ wide×4½″ high and ranging from its deepest point being 2¾″ deep at the top of the pocket to 1½″ deep at the bottom of the pocket, for holding french fries or various taller or open topped containers of food items (the “large pocket” 12).

(g) As illustrated in FIGS. 1, 2 and 6 through 8, said cupholder 18 measuring approximately 3″ square and capable of accommodating beverage containers from small to extra large sizes, and consisting of four (4) sides made from fabric surrounding corresponding hard plastic and being open at the top and bottom. As illustrated in FIGS. 2, 7 and 8, the cupholder 18 is held in its open and upright position by virtue of hook and loop fasteners which connect it to either the right or left of the front lip 26 of the tray together with either the right or left back supports 22 when they are in their open position. When in its open and upright position as illustrated in FIGS. 2, 7 and 8, the cupholder 18 has an opening at the top for a beverage container to be inserted and an opening at the bottom so that said beverage container can rest directly on the tray bottom 28.

(h) As illustrated in FIGS. 1, 2 and 6 through 8, said tray back 8 having a string 16 being approximately 45″ in length (the “drawstring” 16) located horizontally along its top portion and running behind the fabric to which the pockets 14 and 12 are attached and the tray back's 8 corresponding hard plastic and coming out from behind said fabric through holes on either side at both the upper left and upper right of the tray back 8, said drawstring 16 being suspended in air by virtue of its entering the tray again through holes on either side of the front or forward portion of the tray bottom 28 and running under the fabric and corresponding hard plastic contained therein of the tray bottom 28 to meet at a center hole located under the tray bottom 28 through which both ends of the drawstring 16 then emerge and are held together by virtue of a spring loaded plastic mechanism 24 (as illustrated in FIG. 1) which, when used in conjunction with the drawstring 16, is used to adjust the tray bottom 28 to allow for its use in the most level manner possible.

(i) As illustrated in FIGS. 1, 2 and 6 through 10, an adjustable section 30 continuing upward from the tray back 8 at a 90 degree angle from the rear of the tray bottom 28 and being approximately 11½″ wide×6″ high (the “adjustable section” 30), being made from fabric, and containing on either side hook and loop fasteners 6 and 7, being set in from each side a distance of approximately 2¼″, and consisting of an approximately 4″ long fuzzy loop section 6 and a 2½″ long rough loop section 7, as a means to adjust the tray 10 up or down when being used in its hanging position as illustrated in FIGS. 4 through 7. When the tray is being used in the lap position as illustrated in FIGS. 2 and 8, this adjustable section 30 will simply fold backward and hang behind the above described tray back 8.

(j) As illustrated in FIGS. 1, 2, 4 through 8, and 10, an automobile window insert section 4 continuing upward from the adjustable section 30 at a 90 degree angle from the rear of the tray bottom 28 and being approximately 11½″ wide×4¾″ high (the “automobile window insert section” 4), and being made from fabric and including a smaller corresponding hard plastic insert enclosed along the upper portion of the automobile window insert section 4, said hard plastic measuring approximately 11½″ wide×3″ high (this portion of the automobile window insert section 4 being known as the actual “automobile window insert” 2), and said automobile window insert 2 being used by sliding it between the automobile window 36 and its rubber surround 38 and inserting the entire automobile window insert 2 into that portion of the automobile door into which the window disappears by means of the above described window tool 34 provided (said positioning be illustrated in FIGS. 3 and 4, thus allowing the tray 10 to hang down from the window 36 and rest on the door of the automobile, or the body of the automobile if there is no door, whichever the case may be, in its hanging position as illustrated in FIGS. 4 through 7. As previously stated, when the tray 10 is in the lap position as illustrated in FIGS. 2 and 8, the above described adjustable section 30 will simply fold backward and hang behind the above described tray back 8, and this automobile window insert section 4 will then fold under the tray bottom 28 and be held into place by hook and loop fasteners located along the outer edges of the automobile window insert section 4 and along the bottom edges of the tray bottom 28.

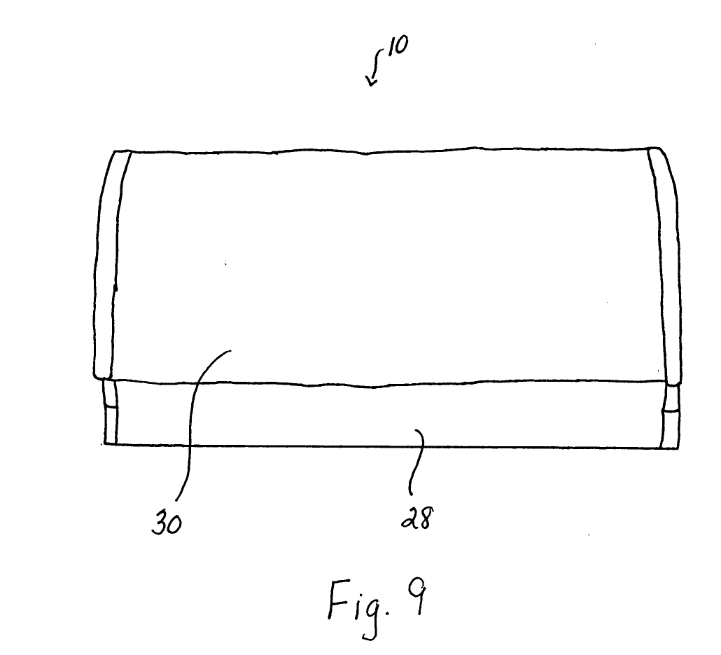

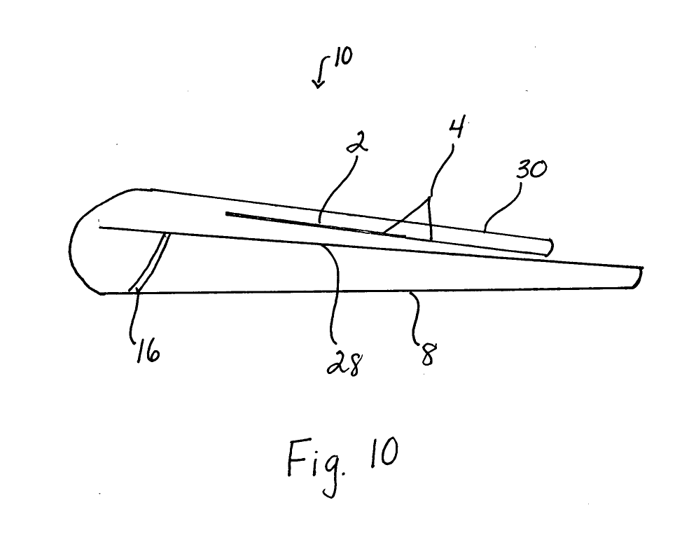

The Eat on the Go Travel Tray for Auto Window or Lap 10 is stored neatly and compactly into a configuration measuring approximately 11½″ wide×6″ tall and varying in depth from ⅛″ along the bottom to 1¼″ along the top (the “storage position”,) as illustrated in FIGS. 9 and 10 and easily fitting into an automobile glove compartment, under the automobile seats, in the storage compartments located in the automobile doors or located on the back of the front driver's and passenger's seats, etc., by folding as follows:

(a) Storing the cupholder 18 in its folded position as illustrated in FIGS. 1 and 6 and being attached by hook and loop fasteners to the tray back 8;

(b) Placing the back supports 22 in their closed position along the tray lip 26;

(c) Folding the tray lip 26 inward, along with the attached back supports 22 and ketchup pockets 20, thus resting on the tray bottom 28;

(d) Folding the tray bottom 28 tightly against the tray back 8 (hereinafter collectively referred to as the “bottom half of the travel tray”) by compacting the pockets 14 and 12 and pulling tight the drawstring 16 and adjustable plastic mechanism 24, thereby exposing a fuzzy loop portion of a hook and loop fastener stitched to the underneath of the tray bottom 28;

(e) Folding the automobile window insert section 4 down against the adjustable section 30 (hereinafter collectively referred to as the “top half of the travel tray”), thereby exposing a rough hook portion of a hook and loop fastener attached to the back side of the automobile window insert section 4;

(f) Folding the tray 10 to its fully closed storage position as illustrated in FIGS. 9 and 10 by folding together the bottom half of the travel tray 10 with the top half of the travel tray 10 and holding these two (2) halves together by means of the aforementioned hook and loop fasteners.

While the invention has been illustrated and described in detail in the drawings, photographs and foregoing description, the same is to be considered as illustrative and not restrictive in character. It should be understood that all changes and modifications that come within the spirit of the invention are desired to be protected.

The invention has been described with reference to the illustrated and presently preferred embodiments. Other modifications and variations of the invention will be readily apparent to those of skill in the art. The foregoing drawings, discussion and descriptions are illustrative of specific embodiments but are not meant to be unduly limited by this disclosure of the presently preferred embodiments. It is to be understood that the following claims are intended to cover all of the generic and specific features of the invention herein described, and all statements of the scope of the invention which, as a matter of language, might be said to fall therebetween. It is intended that the invention be defined, by the means, and their obvious equivalents, set forth in the following claims:

1. A travel tray for holding food and/or beverage items to be utilized by either the driver or passengers in an automobile, or by a person outside of an automobile.

2. The travel tray of claim 1 that may be either attached to an automobile window or utilized on the lap of a person in an automobile or outside of an automobile.

3. The travel tray of claim 1 comprising:
A bottom flat surface (“tray bottom”) having a generally rectangular configuration upon which food items may be placed; and
said tray bottom being surrounded in the front and on both the left and right sides by a lip rising from the bottom flat surface at a 90 degree angle (“tray lip”); and
a back section rising at a 90 degree angle from the rear of the tray bottom having a generally rectangular configuration (“tray back”);
said tray lip and tray back providing a continuous barrier that prevents food items from sliding off the tray bottom.

4. The travel tray of claim 3 also comprising:
“back supports” being attached to the tray lip in both its left and right front corners and being generally of the same shape as the front portion of the tray lip, which in their closed positions lie along the front portion of the tray lip and in their open positions swing to the back of the tray bottom, one on the left and one on the right, and abut the tray back, thus holding the tray in an upright locked open position.

5. The travel tray of claim 3 also comprising:
a small pocket for holding smaller food items being attached to the tray back.

6. The travel tray of claim 3 also comprising:
a large pocket for holding larger food items being attached to the tray back.

7. The travel tray of claim 3 also comprising:
one or more pockets for holding ketchup packets in an upright position (“ketchup pockets”) located on the tray lip on either or both its left and right sides.

8. The travel tray of claim 1 also comprising:
a cupholder having a generally square configuration that is capable of accommodating beverage containers from small to extra large sizes, and consisting of four sides and being open at the top and bottom.

9. The travel tray of claim 3 also comprising:
a drawstring located horizontally along the top portion of the tray back and running under and emerging from a hole in the tray bottom, both ends being held together by virtue of a spring loaded plastic mechanism, said drawstring being used to adjust the tray bottom to allow for its use in the most level manner possible.

10. The travel tray of claim 1 also comprising:
an adjustable section continuing upward from the tray back at a 90 degree angle from the rear of the tray bottom and having a generally rectangular configuration, and being set in on either side hook and loop fasteners as a means to adjust the tray up or down when being used in its hanging position, or in the alternative, the adjustable section will fold backward and hang behind the tray back when the tray is being used in the lap position.

11. The travel tray of claim 1 also comprising:
an automobile window insert section including an automobile window insert which is utilized by sliding the automobile window insert between the automobile window and its rubber surround and inserting the entire automobile window insert into that portion of the automobile door into which the window disappears by means of a window tool, thus allowing the travel tray to hang down from the window in its hanging position, or in the alternative, the automobile window insert section will fold backward and hang behind the tray back and underneath the tray bottom when the tray is being used in the lap position.

12. The travel tray of claim 1 also comprising:
a window tool having rounded and thinned out corners to allow for ease in pulling back a small portion of the automobile window's rubber surround allowing the automobile window insert to slide into place thus allowing the tray to hang down from the window in its hanging position.

13. The travel tray of claim 1 being made from fabric, with the fabric enclosing hard plastic or some such other hard material in the tray bottom, tray back, front of tray lip, and automobile window insert, and with the window tool being made of hard plastic or some such other hard material.

14. The travel tray of claim 1 being foldable and easily carried and stored when in its storage position which is arrived at by storing the cupholder in its folded position and attaching it to the tray back by hook and loop fasteners; placing the back supports in their closed positions; folding the tray lip inward to rest on the tray bottom; folding the tray bottom tightly against the tray back; folding the automobile window insert down against the adjustable section; and folding these two ‘halves’ together and securing with hook and loop fasteners.
